(19) United States
(12) Patent Application Publication
(10) Pub. No.: US 2025/0172279 A1
(43) Pub. Date: May 29, 2025

(54) Method and device for calibrating position and orientation of stage light fixture, electronic device, storage medium, and system

(71) Applicant: Guangzhou Haoyang Electronic Co., Ltd., Guangzhou (CN)

(72) Inventors: Yingru PENG, Guangzhou (CN); Weikai JIANG, Guangzhou (CN); Qiancheng HUANG, Guangzhou (CN); Zhiguang LIANG, Guangzhou (CN); Jianping LIU, Guangzhou (CN)

(21) Appl. No.: 18/650,770

(22) Filed: Apr. 30, 2024

(30) Foreign Application Priority Data
Nov. 28, 2023 (CN) 202311609788.1

(51) Int. Cl. F21V 21/15; F21W 131/406; G06T 7/66; G06T 7/68; G06T 7/73

(52) U.S. Cl. CPC F21V 21/15; G06T 7/66; G06T 7/68; G06T 7/73; F21V 14/02; F21W 2131/406; G06T 2207/30172; G06T 2207/30244

(57) ABSTRACT

A method for calibrating position and orientation of a stage light fixture includes acquiring light spot images and light fixture angle information when light beams of the stage light fixture respectively project on at least three different positions, and calculating first coordinates of a light beam center line projection point image in each of the light spot images in a camera coordinate system; deducing second coordinates of a light beam center line projection point on the stage in a stage coordinate system based on the first coordinates and information about internal parameters and a position and an orientation of a camera when the light spot images are acquired, and recording corresponding relationship between the second coordinates and the light fixture angle information; and determining a calibrated position and orientation of the target stage light fixture based on the second coordinates, the light fixture angle information and the corresponding relationship.

### CROSS REFERENCE TO RELATED APPLICATIONS

The present application claims priority from Chinese Application No. CN 202311609788.1 filed on Nov. 28, 2023, all of which are hereby incorporated herein by reference.

### TECHNICAL FIELD

The present invention relates to the technical field of machine vision and mechanical motion calibration algorithms, in particular to a method for calibrating position and orientation of a stage light fixture and device, an electronic device, a storage medium, and a system.

### BACKGROUND

In the application of stage light fixture, it is sometimes necessary to perform light tracking of object on a stage. At present, the common method is to position the coordinates of objects in a stage coordinate system through positioning sensors, and then convert the coordinates into rotation angles of the stage light fixture, thereby achieving the purpose of light tracking automatically and thus projecting onto the objects on the stage. However, in such method, it is necessary to know a position and an orientation of the light fixture relative to the stage coordinate system in advance, that is, calibration for the light fixture is required.

According to the existing calibrating methods, light of the light fixture is usually manually controlled to project onto a certain position. For example, several positioning sensors are respectively placed at different positions on the stage first; then the light fixture is operated to make center lines of the light beams thereof respectively projecting onto these positions, and the rotation angle information of the light fixture and the coordinate information indicating the positions of the positioning sensors are respectively recorded; the position and the orientation of a chassis of the stage light fixture in the stage coordinate system are calculated according to these information; and finally, according to the position and the orientation of the chassis and the coordinates of the positions to be projected, rotation angle of the light fixture required is calculated.

The disadvantage of such method is that the light fixture is required to manually adjust the projection angle thereof to make the center lines of light beams on the stage located at the positioning sensors. However, the center lines of light beams are invisible for the naked eyes and thus can only be estimated visually, which will cause operational deviation and inconsistent operation, thus affecting the calibrating accuracy.

### SUMMARY

The present invention therefore provides a method for calibrating position and orientation of a stage light fixture and device, an electronic device, a storage medium, and a system, which is free from the drawbacks of unstable calibrating precision in the prior art and can effectively improve the stability of the calibrating precision.

A primary objective of the present invention is to provide a method for calibrating position and orientation of a stage light fixture, including: acquiring light spot images and light fixture angle information when light beams of a target stage light fixture respectively project onto at least three different positions on a stage, and respectively calculating first coordinates of a light beam center line projection point image in each of the light spot images in a camera coordinate system, where the light beam center line projection point image is an image of a projection point of a light beam center line of the target stage light fixture on a floor of the stage; deducing second coordinates of a light beam center line projection point on the stage in a stage coordinate system based on the first coordinates and information about internal parameters and a position and an orientation of a camera for acquiring the light spot images, and recording corresponding relationship between the second coordinates and the light fixture angle information; and determining a calibrated position and orientation of the target stage light fixture based on the second coordinates, the light fixture angle information and the corresponding relationship therebetween.

According to the method provided by the present invention, the method for determining a calibrated position and orientation of the target stage light fixture based on the second coordinates, the light fixture angle information and the corresponding relationship therebetween includes:
establishing a calibration equation set based on the second coordinates, the light fixture angle information and the corresponding relationship therebetween, and solving the calibration equation set by a nonlinear optimization algorithm to acquire an optimal solution as the calibrated position and orientation of the target stage light fixture.

According to the method provided by the present invention, the calibration equation set is as follows:

$${( {l}_{i} , 0 , 0 , 1 )}^{T} = {T}_{light \_ rotation} ( {yaw}_{i} , {pitch}_{i} ) * {T}_{light} * {( {x}_{i} , {y}_{i} , {z}_{i} , 1 )}^{T} , i = 1 … N ,$$

where (xᵢ, yᵢ, zᵢ, 1)^{T} denotes the corresponding second coordinates when the light beams of the target stage light fixture project on a i^{th} position on the stage, T_{light} denotes a first transformation matrix, which is used to transform the second coordinates into third coordinates of the light beam center line projection point on the stage in a light fixture coordinate system, (yawᵢ, pitchᵢ) denotes the corresponding light fixture angle information when the light beams of the target stage light fixture project on the i^{th} position on the stage, T_{light_rotation} (yawᵢ, pitchᵢ) denotes a second transformation matrix, which is a known quantity related to the light fixture angle information and is used to transform the third coordinates into fourth coordinates in a rotating coordinate system formed after the target stage light fixture rotates by an angle of (yawᵢ, pitchᵢ), (lᵢ,0,0,1)^{T} denotes the fourth coordinates, lᵢ denotes a distance from an intersection point of the light beam center line of the target stage light fixture and the floor of the stage to an optical center of the light beam of the target stage light fixture, and N denotes the total number of different positions on the stage projected by the target stage light fixture; and accordingly, the method of solving the calibration equation set to acquire an optimal solution as the calibrated position and orientation of the target stage light fixture includes:
solving the calibration equation set to acquire an optimal value of the first transformation matrix as the calibrated position and orientation of the target stage light fixture.

According to the method provided by the present invention, the nonlinear optimization algorithm is a Levenberg-Marquardt algorithm.

According to the method provided by the present invention, the method of acquiring light spot images and light fixture angle information when light beams of the target stage light fixture respectively project on at least three different positions on the stage includes:
controlling the light beams of the target stage light fixture to respectively project on the at least three different positions to respectively form corresponding light spots; and
respectively collecting images containing the corresponding light spots as the light spot images, and correspondingly recording angle information of the target stage light fixture as the light fixture angle information when the light beams of the target stage light fixture project on the corresponding positions.

According to the method provided by the present invention, the light fixture angle information of the target stage light fixture is determined and recorded when the light beams of the target stage light fixture project on the corresponding positions specifically by determining rotation information of a horizontal motor and rotation information of a vertical motor of the target stage light fixture.

According to the method provided by the present invention, the method of calculating first coordinates of a light beam center line projection point image in each of the light spot images in a camera coordinate system includes:
detecting the light spots in the light spot images by a machine vision algorithm, and determining a position of the light beam center line projection point image according to brightness distributions and shapes of the light spots; and
calculating the first coordinates of the light beam center line projection point image in the camera coordinate system according to the position of the light beam center line projection point image.

According to the method provided by the present invention, specifically, light spot center points on the floor of the stage are taken as the projection point of the light beam center line of the target stage light fixture on the floor of the stage, and accordingly, the light spot center points in the light spot images are taken as the light beam center line projection point images.

According to the method provided by the present invention, the method of calculating the first coordinates of the light beam center line projection point image in each of the light spot images in the camera coordinate system includes:
detecting the light spots in the light spot images by a machine vision algorithm, and
solving coordinates of the light spot center points in the light spot images in the camera coordinate system as the first coordinates of the light beam center line projection point image by a corresponding geometric algorithm according to a geometric characteristic of the light spots in the light spot images.

According to the method provided by the present invention, the light spots in the light spot images are in the shape of an ellipse, the elliptic light spots in the light spot images are detected accordingly by an ellipse detection algorithm, center points of the elliptic light spots are detected as the light spot center points in the light spot images according to the geometric symmetry of the elliptic light spots, and the first coordinates of the light spot center points in the light spot images are calculated.

According to the method provided by the present invention, the method of deducing second coordinates of the light beam center line projection point on the stage in a stage coordinate system based on the first coordinates and information about internal parameters and position and orientation of the camera when the light spot images are acquired includes:
determining a back projection ray by a back projection method based on the first coordinates and the information about the internal parameters and the position and the orientation of the camera; and
based on the back projection ray, determining corresponding points of the light beam center line projection point images in the light spot images on the floor of the stage as the projection points of the light beam center lines on the floor of the stage, and calculating the second coordinates of the projection points in the stage coordinate system.

According to the method provided by the present invention, if the first coordinates of the light beam center line projection point images in the light spot images when the light beams of the target stage light fixture project on the i^{th} position on the stage are (xᵢ^{pixel}, yᵢ^{pixel})^{T}, the back projection ray in the camera in the stage coordinate system is denoted as:

$${u}_{i} = {( K * {T}_{camera} )}^{+} * {( {x}_{i}^{pixel} , {y}_{i}^{pixel} , 1 )}^{T} ,$$

where K, T_{camera} denotes the information about the internal parameters and the position and the orientation of the camera, respectively, (K*T_{camera})⁺ denotes a pseudo-inverse of K*T_{camera}, and uᵢ denotes a straight line on which an imaging focus of the camera and the light beam center line projection point images in the light spot images are located.

A second objective of the present invention is to provide device for calibrating position and orientation of a stage light fixture, including:
a first processing module, configured to acquire light spot images and light fixture angle information when light beams of a target stage light fixture respectively project on at least three different positions on a stage, and respectively calculate first coordinates of a light beam center line projection point image in each of the light spot images in a camera coordinate system, where the light beam center line projection point image is an image of a projection point of a light beam center line of the target stage light fixture on a floor of the stage;
a second processing module, configured to deduce second coordinates of a light beam center line projection point on the stage in a stage coordinate system based on the first coordinates and information about internal parameters and a position and an orientation of a camera for acquiring the light spot images, and record corresponding relationship between the second coordinates and the light fixture angle information; and
a calibrating module, configured to determine a calibrated position and orientation of the target stage light fixture based on the second coordinates, the light fixture angle information and the corresponding relationship therebetween.

A third objective of the present invention is to provide an electronic device, including a memory, a processor, and a program or instruction stored in the memory and operable on the processor, where when the processor executes the program or instruction, the steps of any one of the calibrating methods as mentioned above are implemented.

A fourth objective of the present invention is to provide a non-transient computer-readable storage medium, on which a program or instruction is stored, where when the program or instruction is executed by a computer, the steps of any one of the calibrating methods as mentioned above are implemented.

A fifth objective of the present invention is to provide a computer program product, including a computer program stored on a non-transient computer-readable storage medium, where the computer program includes a program instruction, and when the program instruction is executed by a computer, the computer can execute any one of the calibrating methods as mentioned above.

A sixth objective of the present invention is to provide a system for calibrating position and orientation of a stage light fixture, including at least one group of stage light fixtures, a camera, and a server.

The stage light fixtures are in signal connection with the server, and the server issues a control instruction to control light beams of a target stage light fixture to respectively project onto at least three different positions on a stage.

The camera is installed at a determined position on the stage and is in signal connection with the server, and the camera is used to acquire light spot images when the light beams of the target stage light fixture respectively project on the at least three different positions.

The server is configured to calibrate a position and orientation of the target stage light fixture according to any one of the calibrating methods as mentioned above.

According to the stage light fixture position and orientation calibrating method, and device, the electronic device, the storing medium and the system that are provided by the present invention, by controlling the stage light fixture to project on several positions on the stage at will and reversely deducing the coordinates of the light beam center line projection point on the stage according to the light spot images of these positions, the deviation caused by manual operation can be effectively eliminated, and improved stability of calibration precision is achieved.

### BRIEF DESCRIPTION OF THE DRAWINGS

In order to more clearly illustrate the technical solutions of the present invention or the prior art, the following is a brief introduction to the drawings needed to be used in the description of the embodiments of the present invention or the prior art. Obviously, the drawings in the following description are some embodiments of the present invention. For those of ordinary skill in the art, other drawings may also be derived from these drawings without creative effort.

FIG. 1 is a flow chart of a calibrating method provided by the present invention;

FIG. 2 is a schematic diagram of a light spot center point in a calibrating method provided according to the present invention;

FIG. 3 is a schematic structural diagram of a stage light fixture in a calibrating method provided according to the present invention;

FIG. 4 is another flow chart of a calibrating method provided by the present invention;

FIG. 5 is a schematic structural diagram of a calibrating device provided by the present invention;

FIG. 6 is a schematic diagram of a physical structure of an electronic device provided by the present invention; and

FIG. 7 is a schematic structural diagram of a calibrating system provided by the present invention.

### DETAILED DESCRIPTION

In order to make the purpose, the technical solution and the advantages of the present invention clearer, the technical solution of the present invention will be clearly and completely described below in conjunction with the accompanying drawings of the present invention. Obviously, the described embodiments are part of the embodiments of the present invention, but not all of the embodiments. Based on the embodiments of the present invention, all other embodiments, obtained by those of ordinary skill in the art without creative work, shall fall within the scope of protection of the present invention.

In the present invention, aiming at the problems of unstable calibrating precision in the prior art, by controlling the stage light fixture to project onto several positions on the stage at will and reversely deducing the coordinates of a projection point of the center line of the light beam on the stage according to the light spot images of these positions, the deviation caused by manual operation can be effectively eliminated, and improved stability of calibrating precision can achieve. The present invention will be described and illustrated below in conjunction with the embodiments illustrated in the drawings.

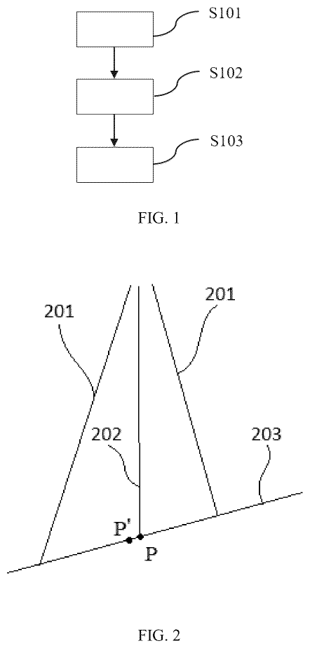

FIG. 1 shows a flow chart of a method for calibrating position and orientation of a stage light fixture according to the present invention.

In step S101, acquiring light spot images and the light fixture angle information when light beams of the target stage light fixture respectively project onto at least three different positions on a stage, and respectively calculating first coordinates of a light beam center line projection point image in each of the light spot images in a camera coordinate system.

In the context of the present invention, the projection point image of the light beam center line of the refers to an image of a projection point of a light beam center line of the target stage light fixture on a floor of the stage.

It should be understood that in the present invention, the coordinates of the projection point images of the light beam center line in the light spot images in a picture are calculated according to the information of the light spot images with light spots projected onto the floor by the target stage light fixture, such information is collected by the camera. Specially, the target stage light fixture is controlled to enable the light beams thereof to respectively project on several different positions on the stage, that is, at least three different positions, and then form corresponding light spots at the respective positions on the stage projected by light. Each position where the light projects is subjected to image acquisition to obtain an image containing a light spot at the position, referred as a light spot image. Meanwhile, at each position where the light projects, the target stage light fixture is controlled to rotate to a corresponding angle, and the value of the angle is read and recorded as the light fixture angle information. The number of the positions projected by the light fixture is at least three, and preferably five.

Subsequent to acquiring the light spot images containing the light spots, the light spots contained in the light spot images are detected, and images formed in the light spots by the projection point of the light beam center line of the target stage light fixture on the floor of the stage is determined, such images determined is the light beam center line projection point image. Then, according to the position of the light beam center line projection point image in the light spot image and information about position, internal parameters and the like of the camera used to collect the light spot image, the coordinates of the light beam center line projection point image in the camera coordinate system are calculated, referred as the first coordinates.

Additionally, the method of calculating the first coordinates of the light beam center line projection point image in each of the light spot images in a camera coordinate system includes: detecting the light spots in the light spot images by machine vision algorithm, and determining a position of the light beam center line projection point image according to brightness distribution and shape of the light spots; and calculating the first coordinates of the light beam center line projection point image in the camera coordinate system according to the position of the light beam center line projection point image.

It should be understood that: considering that the sum of the luminous fluxes of the light spots on the left side of the light beam center line is equal to that of the luminous fluxes of the light spots on the right side of the light beam center line, the projection point P of the light beam center line thus can be calculated according to the brightness distribution and shape of the light spot. Specifically, a line may be obtained according to the brightness distribution (the sums of the luminous fluxes on two sides of the line are equal), and then a midpoint is taken in conjunction with the shape, the light beam center line projection point image thus may be found.

According to the present invention, a light spot center point on the floor of the stage can be taken as the projection point of the light beam center line of the target stage light fixture on the floor of the stage, and accordingly, the light spot center point in each light spot image can be taken as the light beam center line projection point image.

It should be understood that in the present invention, the light spot center point P′ in the light spot formed by the light beams of the target stage light fixture projecting on the floor of the stage are approximately taken as the projection point P of the light beam center line (namely the light beam center line projection point is an intersection point between the light beam center line of the light fixture and the floor), which facilitates calculation. Accordingly, the light spot images obtained, in the image acquisition for the light spots formed on the stage, also contain the images of the light spot center points, namely the light spot center points in the light spot images.

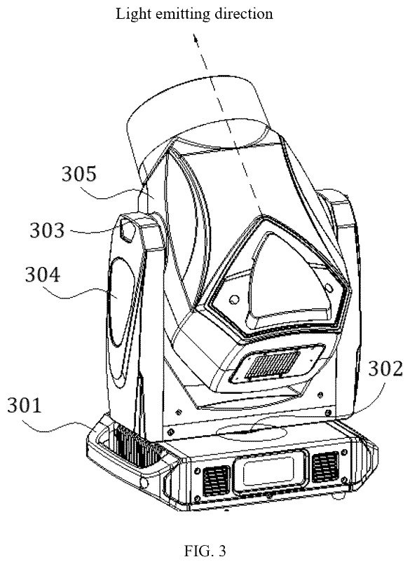

Specifically, as shown in FIG. 2 which is a schematic diagram of a light spot center point in the calibrating method provided according to the present invention, a ray 201 indicates a light beam boundary line of the target stage light fixture, a ray 202 indicates a light beam center line, and a straight line 203 indicates a floor of a stage. When an included angle between the light beam center line 202 and the floor 203 of the stage is between 50° and 90° and a projection distance is within 30 m, there is only very less offset between the light beam center line projection point P and the light spot center point P of the stage. Therefore, the light beam center line projection point P and the light spot center point P of the stage may be approximately overlapped for rough positioning.

Alternatively, the method of calculating the first coordinates of the light beam center line projection point image in each of the light spot images in the camera coordinate system includes: detecting the light spots in the light spot images by machine vision algorithm, and obtaining coordinates of the light spot center points in the light spot images in the camera coordinate system as the first coordinates of the light beam center line projection point image by a corresponding geometric algorithm according to a geometric characteristic of the light spots in the light spot images.

It should be understood that in the present invention, according to the geometrical shapes of the light spots, a corresponding machine vision algorithm can be used to detect the positions of the light spots in the light spot images. For example, when the shapes of the light spots projected by the light are an ellipse (or a rectangle or a triangle), an ellipse (or a rectangle or a triangle) detection algorithm is correspondingly used to detect the positions of the ellipses (or the rectangles or the triangles) in the light spot images.

Then, according to the detected information about the positions of the light spots, the coordinates of the light spot center points in the light spot images in the camera coordinate system can be calculated in conjunction with the geometric shapes of the light spots and the information about the positions, the internal parameters and the like of the camera used to collect the light spot images, such coordinates are taken as the first coordinates of the light beam center line projection point image.

Particularly, if the light spots in the light spot images are in the shape of an ellipse, the elliptic light spots in the light spot images are detected accordingly by an ellipse detection algorithm. In this case, center points of the elliptic light spots are detected as the light spot center points in the light spot images according to the geometric symmetry of the elliptic light spots, and the first coordinates of the light spot center points in the light spot images are then calculated.

It should be understood that in the present invention, when the light beams of the target stage light fixture are controlled to project on a position of the stage, a light cone of the light of the light fixture is projected onto the floor to form an elliptical light spot. Light spot images containing the elliptical light spots on the floor are acquired by the camera, the positions of the ellipses in the light spot images are detected through the ellipse detection algorithm, and then the first coordinates of light spot center points p in the light spot images are calculated according to the positions, where the ellipse detection algorithm particularly may be an ellipse detection algorithm of a cross-platform computer vision library OpenCV.

In step S102, deducing second coordinates of a light beam center line projection point on the stage in a stage coordinate system based on the first coordinates and information about internal parameters and the position and orientation of the camera for acquiring the light spot images, and recording the corresponding relationship between the second coordinates and the light fixture angle information.

According to the present invention, on the basis of acquiring the first coordinates of the light beam center line projection point images in the light spot images, the coordinates of the actual light beam center line projection points on the stage in the stage coordinate system, referred to as the second coordinates, are reversely deduced through back projection based on the first coordinates in conjunction with the information about the internal parameters and the position and the orientation of the camera for collecting the light spot images. Meanwhile, according to the corresponding relationship between the light spot images and the light fixture angle information, the corresponding relationship between the second coordinates of the light beam center line projection points on the stage and the light fixture angle information is determined and recorded.

That is, the second coordinates of the light beam center line projection points P on the stage are reversely deduced in a manner of back projection according to the first coordinates of the light beam center line projection point images on the light spot images in conjunction with the internal parameters and the position and the orientation of the camera, and multiple groups of corresponding relationship data between the second coordinates and the light fixture angle information are obtained in this process. In a well-known way, the internal parameters and the position and the orientation of the camera may be obtained in advance through a common camera calibration algorithm, such as a Zhang's calibration method.

Alternatively, the coordinates of the back projection points on the floor of the stage after the back projection of the light spot center points on the light spot images may be obtained to replace the second coordinates of the light beam center line projection points on the stage in the stage coordinate system. Meanwhile, the corresponding relationship between the second coordinates of the light beam center line projection points and the angle information of the target stage light fixture are correspondingly replaced by the corresponding relationship between the coordinates of the back projection points and the angle information of the target stage light fixture to perform the corresponding calibration work.

The steps of collecting the light spot images and calculating the second coordinates of the light beam center line projection points on the stage in steps S101 to S102 are repeated to obtain a plurality of groups of second coordinates and corresponding relationship between the second coordinates and the light fixture angle information.

In step S103, a calibrated position and orientation of the target stage light fixture is determined based on the second coordinates, the light fixture angle information, and the corresponding relationship therebetween.

According to the present invention, after the second coordinates of the light beam center line projection points on the stage, the light fixture angle information, and the corresponding relationship therebetween are determined, the transformation relationship from the stage coordinate system to the light fixture coordinate system may be reversely deduced, that is, the calibrated position and orientation of the target stage light fixture are deduced. It should be understood that the calibrated position and orientation of the target stage light fixture are information about installation position and angle of the target stage light fixture.

Particularly, the method of determining the calibrated position and orientation of the target stage light fixture based on the second coordinates, the light fixture angle information, and the corresponding relationship therebetween includes: establishing a calibration equation set based on the second coordinates, the light fixture angle information, and the corresponding relationship therebetween, and solving the calibration equation set by a nonlinear optimization algorithm to obtain an optimal solution as the calibrated position and orientation of the target stage light fixture.

In the present invention, the second coordinates of the corresponding at least three light beam center line projection points on the stage are obtained by controlling the light beams of the target stage light fixture to project onto at least three different positions of the stage, transformation relationship from the stage coordinate system to the target stage light fixture coordinate system may be reversely deduced in a manner of establishing a calibration equation set, and the calibrated position and orientation of the target stage light fixture thus can be further determined according to the coordinates of any point on the stage.

Specifically, a nonlinear equation set may be established as the calibration equation set based on the second coordinates of the light beam center line projection points on the stage in the stage coordinate system, the angle information of the target stage light fixture when the light projects on the corresponding positions of the light beam center line projection points, and the corresponding relationships between the second coordinates and the light fixture angle information. Then, the nonlinear optimization algorithm is used to perform optimal solving on the calibration equation set to obtain an optimal solution of the calibration equation set and take the optimal solution as the calibrated position and orientation of the target stage light fixture.

According to the method for calibrating position and orientation of the stage light fixture provided by the present invention, by controlling the stage light fixture to project onto several positions on the stage at will and reversely deducing the coordinates of the light beam center line projection points on the stage according to the light spot images of these positions, the deviation caused by manual operation can be effectively eliminated, and improved stability of calibration precision can achieve.

According to the embodiments of the method, the calibration equation set may be as follows:

$${( {l}_{i} , 0 , 0 , 1 )}^{T} = {T}_{light \_ rotation} ( {yaw}_{i} , {pitch}_{i} ) * {T}_{light} * {( {x}_{i} , {y}_{i} , {z}_{i} , 1 )}^{T} , i = 1 … N ,$$

where (xᵢ, yᵢ, zᵢ, 1)^{T} denotes the corresponding second coordinates when the light beams of the target stage light fixture project onto the i^{th} position on the stage, T_{light} denotes a first transformation matrix, which is used to transform the second coordinates into third coordinates of the light beam center line projection point on the stage in a light fixture coordinate system, (yawᵢ, pitchᵢ) denotes the corresponding light fixture angle information when the light beams of the target stage light fixture project onto the i^{th} position on the stage, T_{light_rotation} (yawᵢ, pitchᵢ) denotes a second transformation matrix, which is a known quantity related to the light fixture angle information and is used to transform the third coordinates into fourth coordinates in a rotating coordinate system formed after the target stage light fixture rotates by an angle of (yawᵢ, pitchᵢ), (lᵢ,0,0,1)^{T} denotes the fourth coordinates, lᵢ denotes a distance from an intersection point between the light beam center line of the target stage light fixture and the floor of the stage to an optical center of the light beam of the target stage light fixture, and N denotes the total number of different positions on the stage projected by the target stage light fixture. The equation set may also be referred to as a hand-eye calibration equation set.

Accordingly, the method of solving the calibration equation set to acquire an optimal solution as the calibrated position and orientation of the target stage light fixture includes: solving the calibration equation set to acquire an optimal value of the first transformation matrix as the calibrated position and orientation of the target stage light fixture.

In the present invention, the coordinates of the light beam center line projection points P of the stage in the stage coordinate system can be transformed into the coordinates in the light fixture coordinate system through a coordinate transformation matrixT_{light}, and then the coordinates of the light beam center line projection points P of the stage in the light fixture coordinate system are transformed into coordinates in the rotating coordinate system after the light fixture is rotated through another coordinate transformation matrixT_{light_rotation} (yawᵢ, pitchᵢ), so as to establish a calibration equation. That is, the calibration equation set is established according to the above at least three groups of second coordinates and the corresponding relationship between the second coordinates and the light fixture angle information, and finally the optimal value of the coordinate transformation matrixT_{light} is solved by an optimization method.

In the present invention, the first transformation matrixT_{light} can transform the second coordinates of the light beam center line projection point on the stage in the stage coordinate system into the third coordinates in the light fixture coordinate system, so that as long as the first transformation matrix is known, the coordinates of any position on the stage in the stage coordinate system may be transformed into the position and orientation coordinate information in the light fixture coordinate system, thereby adjusting, according to the position and orientation coordinate information the target stage light fixture to project onto any position as mentioned above.

That is to say, once the first transformation matrix is solved, the calibration of the target stage light fixture is completed, and as long as the position and the orientation of the chassis of the target stage light fixture do not change, under coordinates of any points on the stage, the corresponding (light head or support arm) rotation angleT_{light_rotation} (yawᵢ, pitchᵢ) can be reversely deduced in any time by the matrix in conjunction with the aforementioned calibration equation set, so that the light beams may be projected onto the corresponding point positions.

In the above calibration equation set, T_{light} is a coordinate system transformation matrix that is used to transform coordinates of the light beam center line projection point P of the stage from the stage coordinate system to coordinates in the light fixture coordinate system (corresponding to the position and the orientation of the light fixture, which is the content needing to be solved); T_{light_rotation} (yawᵢ, pitchᵢ) is also a coordinate system transformation matrix that is used to transform coordinates of the light beam center line projection point P of the stage in the light fixture coordinate system to coordinates in the rotating coordinate system after the light fixture rotates by an angle of (yawᵢ, pitchᵢ), which is a known quantity related to the angle (yawᵢ, pitchᵢ) and can be derived from the angle data; (lᵢ,0,0,1)^{T} is coordinates of the light beam center line projection point P of the stage in the rotating coordinate system after the light fixture rotates by an angle of (yawᵢ, pitchᵢ), lᵢ is a distance from an intersection point between the light beam center line of the light fixture and the floor to an optical center of the light beam of the light fixture, which is an unknown variable, and may also can be solved according to the above calibration equation set. Assuming that the light beam center line coincides with the X-axis in the coordinate system, lᵢ corresponds to the coordinates of the X-axis in the light fixture coordinate system after rotating by an angle of (yawᵢ, pitchᵢ), and (0, 0) denotes the coordinate value of the y-axis and the coordinate value of the z-axis, respectively. N calibration equations are established, and the optimal solutionT_{light} solved by nonlinear optimization may be used as the calibrated position and orientation of the light fixture.

In the present invention, a solving algorithm of the nonlinear equation set may be adopted to carry out optimization calculation and solution on the calibration equation set so as to obtain the optimal value of the first transformation matrix. And the optimal value is used as the calibrated position and orientation of the target stage light fixture.

Particularly, the nonlinear optimization algorithm may be a Levenberg-Marquardt algorithm. The above calibration equation set is correspondingly solved by the Levenberg-Marquardt algorithm to obtain an optimal value of the first transformation matrixT_{light}, and the optimal value is taken as the calibrated position and orientation of the target stage light fixture, so that the current position and orientation of the stage light fixture can be adjusted according to the calibrated position and orientation and the positions of object on the stage, and accurate light tracking of the personnel on the stage is thus realized.

In the present invention, by establishing the nonlinear calibration equation set, the transformation relationship among the coordinate systems is established, and the calibration equation set is subjected to optimal solving to obtain the transformation matrix from the stage coordinate system to the light fixture coordinate system, thereby obtaining the calibrated position and orientation of the target stage light fixture, which is a simple solving process while with higher accuracy.

According to the present invention, the method of acquiring light spot images and light fixture angle information when light beams of the target stage light fixture respectively project on at least three different positions on the stage includes: controlling the light beams of the target stage light fixture to respectively project onto the at least three different positions to respectively form corresponding light spots; and respectively collecting images containing the corresponding light spots as the light spot images, and correspondingly recording angle information of the target stage light fixture as the light fixture angle information when the light beams of the target stage light fixture project onto the corresponding positions.

It can be understood that in the present invention, for any target stage light fixture to be calibrated, the light beams of the target stage light fixture may be controlled to sequentially project onto several positions (that is, at least three different positions) in a site of the stage, and the corresponding data of the light fixture angle (that is, the light fixture angle information) at this time may be recorded. The camera collects the images of the light spots (corresponding light spots) formed by the light of the target stage light fixture projected onto the floor of the stage, that is, the light spot images are obtained. It can be understood that the above corresponding light spots are the light spots corresponding to the corresponding positions, and the corresponding positions are the corresponding positions on which the light projects, and are also the positions corresponding to the light fixture angle information and the light spots.

More particularly, the light fixture angle information of the target stage light fixture is determined and recorded, when the target stage light fixture projects on the corresponding positions, specifically by determining rotation information of a horizontal motor and rotation information of a vertical motor of the target stage light fixture.

The structure of the target stage light fixture according to an embodiment of the present invention is shown in FIG. 3, which is a schematic structural diagram of the stage light fixture in the method provided according to the present invention. The target stage light fixture includes a chassis 301, a horizontal motor 302, a vertical motor 303, a support arm 304, and a light head 305, wherein the chassis 301 is fixed, and the support arm 304 rotates horizontally relative to the chassis 301, and the light head 305 rotates vertically relative to the arm 304. The vertical motor 303 drives the light head to rotate relative to the support arm 304, and the horizontal motor 302 drives the support arm 304 to rotate relative to the light head. The calibrated position and orientation of the stage light fixture in this case refer to an installation position and an angle of the chassis 301.

By controlling the horizontal motor 302 and the vertical motor 303 to rotate, the target stage light fixture can be adjusted to the corresponding angle, that is, there is certain corresponding relationship between the rotation information of the horizontal motor 302 and the vertical motor 303 of the light fixture and the angle information of the stage light fixture. Therefore, by determining the rotation information of the horizontal motor and the rotation information of the vertical motor of the target stage light fixture, the angle information of the target stage light fixture, that is, the light fixture angle information, when the target stage light fixture projects onto the corresponding position, can be determined and recorded. The position and the orientation of the target stage light fixture relative to the stage coordinate system thus can be calculated by combining the second coordinates of the light beam center line projection point on the stage and the rotation information of the horizontal (driving the support arm to rotate) motor and the vertical (driving the light head to rotate) motor of the target stage light fixture.

In particular, according to the method of the present invention the method of deducing second coordinates of the light beam center line projection point on the stage in the stage coordinate system, based on the first coordinates and the information about internal parameters and the position and the orientation information of the camera for acquiring the light spot images, includes: determining a back projection ray by a back projection method based on the first coordinates and the information about the internal parameters and the position and the orientation of the camera; and based on the back projection ray, determining corresponding points of the light beam center line projection point images in the light spot images on the floor of the stage as the projection points of the light beam center lines on the floor of the stage, and calculating the second coordinates of the projection points in the stage coordinate system.

In the present invention, the light spot center point on the floor of the stager is approximately taken as the projection point of the light beam center line, and accordingly, the light spot center point in the light spot image is approximately taken as the image of the projection point, so that the light spot center point in the light spot image is back-projected onto the floor of the stage through the internal parameters and the orientation of the camera to obtain a back projection ray. After that, the intersection point between the back projection ray and the floor of the stage may be solved to obtain the corresponding point of the light spot center point in the light spot image on the floor of the stage as the projection point of the light beam center line. That is, the light spot center point in the light spot image is back-projected onto the floor in a stage space coordinate system to obtain a back projection point as the light spot center point on the floor of the stage. Then, the second coordinates of the light spot center point on the stage in the stage coordinate system are calculated, and the current angle information of the target stage light fixture is recorded at the same time, for example, the angle information of the target stage light fixture may be determined through the respective rotation angles of the horizontal motor and the vertical motor of the light fixture.

More particularly, if the first coordinates of the light beam center line projection point images in the light spot images when the light beams of the target stage light fixture project onto the i^{th} position on the stage are (xᵢ^{pixel}, yᵢ^{pixel})^{T}, the back projection ray in the camera in the stage coordinate system is denoted as:

$${u}_{i} = {( K * {T}_{camera} )}^{+} * {( {x}_{i}^{pixel} , {y}_{i}^{pixel} , 1 )}^{T} ,$$

where K, T_{camera} denotes the information about the internal parameters and the position and the orientation of the camera, respectively, (K*T_{camera})⁺ denotes a pseudo-inverse of K*T_{camera}, and uᵢ denotes a straight line on which an imaging focus of the camera and the light beam center line projection point images in the light spot images are located.

In the present invention, the internal parameters and the orientation of the camera are calibrated as K,T_{camera} respectively in advance by a camera calibration method, such as Zhang's calibration algorithm. Assuming that the stage space coordinates of the floor are z=0, that is, the floor is a plane defined by X-Y axes. The inverse projection ray of the coordinates (xᵢ^{pixel}, yᵢ^{pixel})^{T} of the light beam center line projection point images in the light spot images in the stage coordinate system may be obtained through the back projection equation as above, and an intersection point of the ray and a stage floor plane zᵢ=0 may be further calculated as (xᵢ, yᵢ, zᵢ), namely the stage space coordinates corresponding to the light beam center line projection point on the floor.

According to an embodiment of the method, the method of calculating the second coordinates of light spot center points on the floor in the stage coordinate system includes: projecting the light spots in the light spot images onto the floor in the stage coordinate system by a back projection method to acquire light spots on the stage, determining projection points of the light beam center lines on the floor of the stage coordinate system according to the brightness distributions and the shapes of the light spots on the stage; and calculating the second coordinates of the projection point on the stage coordinate system.

In the present invention, when the coordinates of the projection points of the light spot center points on the stage are obtained, the whole light spots in the light spot images may be back-projected onto the stage to obtain the whole light spot images on the stage first, and then the projection point P of the light beam center line is calculated according to the brightness distributions and shapes of the light spots, because the sum of the luminous fluxes of the light spots on the left side of the light beam center line is equal to the sum of the luminous fluxes of the light spots on the right side of the light beam center line.

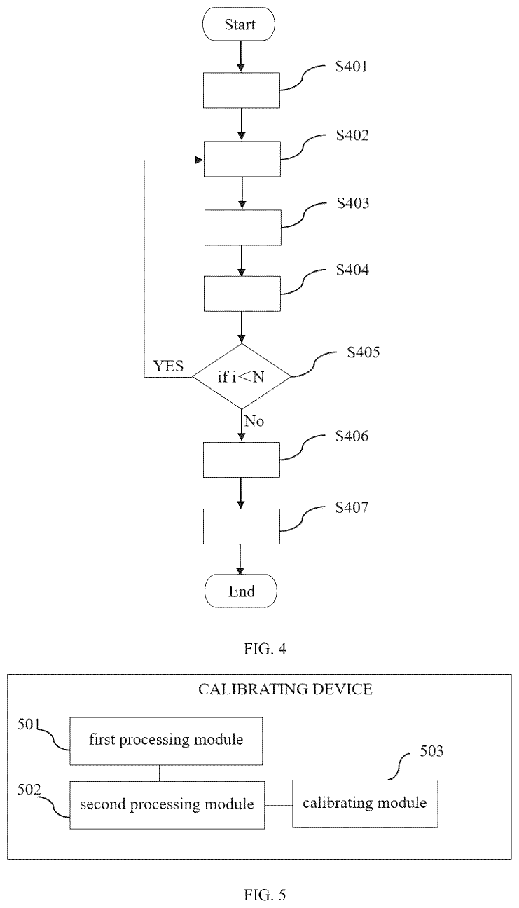

In order to further illustrate the method of the present invention, a more detailed description is given below in conjunction with FIG. 4, but not limited to the scope of protection claimed by the present invention.

FIG. 4 depicts a more detailed flow chart of the method provided by the present invention, including the following processing steps.

In step S401, calibrating the camera by a Zhang's calibration method to obtain the internal parameters and the position and the orientation K,T_{camera} of the camera.

In step S402, calculating the rotation (yawᵢ, pitchᵢ) angle of the target stage light fixture controlled by the server, so that the light is projected onto a certain place on the floor.

In step S403, acquiring, by the camera, an image containing light spots on the floor, runing, by the server, an ellipse detection algorithm of a cross-platform computer vision library Opencv to detect an ellipse position, and calculating first coordinates (xᵢ^{pixel}, yᵢ^{pixel})^{T} of an ellipse center point in the image in the camera coordinate system according to the geometric symmetry of the ellipse.

In step S404, obtaining an inverse projection ray uᵢ=(K(T_{camera})⁺*(xᵢ^{pixel}, yᵢ^{pixel}) of the first coordinates (xᵢ^{pixel}, yᵢ^{pixel})^{T} of the ellipse center point in the camera through a back projection equation, and calculating an intersection point (xᵢ, yᵢ, zᵢ) of the ray and the stage floor plane zᵢ=0. Where (K*T_{camera})⁺ is a pseudo-inverse of K*T_{camera}.

In step S405, repeating the steps S402 to S404 for N times to obtain N groups of data {xᵢ, yᵢ, zᵢ, yawᵢ, pitchᵢ}, i=1 . . . N. Where the value of N is at least 3, preferably 5. The calibrating accuracy may be improved by increasing the number of repeated steps.

In step S406, establishing a calibration equation set:

$${( {l}_{i} , 0 , 0 , 1 )}^{T} = {T}_{light \_ rotation} ( {yaw}_{i} , {pitch}_{i} ) * {T}_{light} * {( {x}_{i} , {y}_{i} , {z}_{i} , 1 )}^{T} , i = 1 … N .$$

where (xᵢ, yᵢ, zᵢ, 1)^{T} is coordinates of a light spot center point P on the stage in the stage coordinate system, namely second coordinates of the center point of the elliptical light spot on the floor of the stage in the stage coordinate system; T_{light} is a first transformation matrix that is a coordinate system transformation matrix for transforming a coordinate value of the light spot center point P′ on the stage from the stage coordinate system to the light fixture coordinate system (corresponding to the position and the orientation of the light fixture, which is to be solved); T_{light_rotation}(yawᵢ, pitchᵢ) is a second transformation matrix of the coordinate system, which is used to transform a coordinate value of the light spot center point P′ on the stage in the light fixture coordinate system to a coordinate value in the rotating coordinate system after the light fixture rotates by an angle of (yawᵢ, pitchᵢ), which is a known quantity related to the rotation angle (yawᵢ, pitchᵢ); (lᵢ,0,0,1)^{T} is a coordinate value of the light spot center point P′ on the stage in the rotating coordinate system after the light fixture rotates by an angle of (yawᵢ, pitchᵢ); lᵢ is a distance from an intersection point between the light fixture beam center line and the floor to an optical center of the light beam of the stage, which is an unknown variable, may be solved through the calibration equation set, and is equivalent to the x-axis coordinate value in the light fixture coordinate system after rotating by an angle of (yawᵢ, pitchᵢ), 0,0 respectively denote a y-axis coordinate value and a z-axis coordinate value, and in the present invention, the light beam center line is stipulated to coincide with the x-axis in the coordinate system.

In step S407, solving the above calibration equation set through a nonlinear optimization algorithm, such as a Levenberg-Marquardt algorithm, so as to obtain an optimal solution T̆_{light} as a calibrated position and orientation of the light fixture. After the optimal solutionT̆_{light} is obtained, the calibration of the light fixture is completed. As long as the position and the orientation of the chassis of the light fixture do not change, under coordinates of any point on the stage, the corresponding (light head, support arm) rotation angle T_{light_rotation}(yawᵢ, pitchᵢ) can be reversely deduced in any time by the matrix in conjunction with the aforementioned calibration equation set, so that the light beams may be projected onto the corresponding point positions.

Based on the same inventive concept, the present invention further provides a device for calibrating position and orientation of the stage light fixture, which is used to conduct the method of calibrating the position and the orientation of the stage light fixture as mentioned above. Therefore, the description and the definition in the calibrating method above may be used for the understanding of each execution module in the present invention, and the specific reference may be made to the above method embodiments, which are not described here.

According to one embodiment of the present invention, refereeing to FIG. 5, the calibrating device for implementing the method mentioned above includes a first processing module 501, a second processing module 502, and a calibrating module 503.

The first processing module 501 is configured to acquire light spot images and light fixture angle information when light beams of a target stage light fixture respectively project onto at least three different positions on a stage, and respectively calculate first coordinates of a light beam center line projection point image in each of the light spot images in a camera coordinate system, where the light beam center line projection point image is an image of a projection point of a light beam center line of the target stage light fixture on a floor of the stage.

The second processing module 502 is configured to calculate second coordinates of a light beam center line projection point on the stage in a stage coordinate system based on the first coordinates and information about internal parameters and a position and an orientation of a camera for acquiring the light spot images, and record corresponding relationship between the second coordinates and the light fixture angle information.

The calibrating module 503 is configured to determine a calibrated position and orientation of the target stage light fixture based on the second coordinates, the light fixture angle information and the corresponding relationship therebetween.

According to the calibrating device provided by the present invention, by controlling the stage light fixture to project on several positions on the stage at will and reversely deducing the coordinates of the light beam center line projection points on the stage according to the light spot images of these positions, the deviation caused by manual operation can be effectively eliminated, and improved stability of calibration precision is achieved.

Particularly, the calibrating module is used to determine a calibrated position and orientation of the target stage light fixture based on the second coordinates, the light fixture angle information and the corresponding relationship, specifically in a way of:
establishing a calibration equation set based on the second coordinates, the light fixture angle information and the corresponding relationship, and solving the calibration equation set by adopting a nonlinear optimization algorithm to acquire an optimal solution as the calibrated position and orientation of the target stage light fixture.

More particularly, the calibration equation set is as follows:

$${( {l}_{i} , 0 , 0 , 1 )}^{T} = {T}_{light \_ rotation} ( {yaw}_{i} , {pitch}_{i} ) * {T}_{light} * {( {x}_{i} , {y}_{i} , {z}_{i} , 1 )}^{T} , i = 1 … N ,$$

where in the formula, (xᵢ, yᵢ, zᵢ, 1)^{T} denotes the corresponding second coordinates when the light beams of the target stage light fixture project onto the i^{th} position on the stage, T_{light} denotes a first transformation matrix, which is used to transform the second coordinates into third coordinates of the light beam center line projection point on the stage in a light fixture coordinate system, (yawᵢ, pitchᵢ) denotes the corresponding light fixture angle information when the light beams of the target stage light fixture project onto the i^{th} position on the stage, T_{light_rotation} (yawᵢ, pitchᵢ) denotes a second transformation matrix, which is a known quantity related to the light fixture angle information and is used to transform the third coordinates into fourth coordinates in a rotating coordinate system formed after the target stage light fixture rotates by an angle of (yawᵢ, pitchᵢ), (lᵢ,0,0,1)^{T} denotes the fourth coordinates, lᵢ denotes a distance from an intersection point between the light beam center line of the target stage light fixture and the floor of the stage to an optical center of the light beam of the target stage light fixture, and N denotes the total number of different positions on the stage projected on by the target stage light fixture.

Accordingly, the method of solving the calibration equation set to acquire an optimal solution as the calibrated position and orientation of the target stage light fixture includes:
solving the calibration equation set to acquire an optimal value of the first transformation matrix as the calibrated position and orientation of the target stage light fixture.

More particularly, the nonlinear optimization algorithm may be a Levenberg-Marquardt algorithm.

According to the present invention, the first processing module is used to acquire the light spot images and the light fixture angle information when the light beams of the target stage light fixture respectively project onto at least three different positions on the stage, specifically in a way of:
controlling the light beams of the target stage light fixture to respectively project onto the at least three different positions to respectively form corresponding light spots; and
respectively collecting images containing the corresponding light spots as the light spot images, and correspondingly recording angle information of the target stage light fixture as the light fixture angle information when the light beams of the target stage light fixture project onto the corresponding positions.

In addition, the first processing module is further used to determine and record the light fixture angle information of the target stage light fixture when the light beams of the target stage light fixture project on the corresponding positions specifically by determining rotation information of a horizontal motor and rotation information of a vertical motor of the target stage light fixture.

According to the present invention, the first processing module is used to calculate the first coordinates of the light beam center line projection point image in each of the light spot images in the camera coordinate system, in a way of:
detecting the light spots in the light spot images by a machine vision algorithm, and determining a position of the light beam center line projection point image according to brightness distributions and shapes of the light spots; and
calculating the first coordinates of the light beam center line projection point image in the camera coordinate system according to the position of the light beam center line projection point image.

Particularly, according to an embodiment of the present invention, the second processing module is specifically configured to take the light spot center point on the floor of the stage as the projection point of the light beam center line of the target stage light fixture on the floor of the stage, and accordingly take the light spot center points in the light spot images as the light beam center line projection point images.

Particularly, according to an embodiment of the present invention, the first processing module is used to calculate the first coordinates of the light beam center line projection point image in each of the light spot images in the camera coordinate system, in a way of:
detecting the light spots in the light spot images by the machine vision algorithm, and solving coordinates of the light spot center points in the light spot images in the camera coordinate system as the first coordinates of the light beam center line projection point image by a corresponding geometric algorithm according to a geometric characteristic of the light spots in the light spot images.

According to an embodiment of the present invention, the light spots in the light spot images are in the shape of an ellipse, and accordingly, the first processing module is configured to detect the elliptic light spots in the light spot images by adopting an ellipse detection algorithm, detect center points of the elliptic light spots as the light spot center points in the light spot images according to geometric symmetry of the elliptic light spots, and calculate the first coordinates of the light spot center points in the light spot images.

Particularly, according to an embodiment of the present invention, the second processing module is used to deduce the second coordinates of the light beam center line projection point on the stage in the stage coordinate system based on the first coordinates and the information about the internal parameters and the position and the orientation of the camera for acquiring the light spot images, in a way of:
determining a back projection ray by a back projection method based on the first coordinates and the information about the internal parameters and the position and the orientation of the camera; and
based on the back projection ray, determining corresponding points of the light beam center line projection point images in the light spot images on the floor of the stage as the projection points of the light beam center lines on the floor of the stage, and calculating the second coordinates of the projection points in the stage coordinate system.

Specifically, if the first coordinates of the light beam center line projection point images in the light spot images when the light beams of the target stage light fixture project onto the i^{th} position on the stage are (xᵢ^{pixel}, yᵢ^{pixel})^{T} the back projection ray in the camera in the stage coordinate system is denoted as:

$${u}_{i} = {( K * {T}_{camera} )}^{+} * {( {x}_{i}^{pixel} , {y}_{i}^{pixel} , 1 )}^{T} ,$$

where K,T_{camera} denotes the information about the internal parameters and the position and the orientation of the camera, respectively, (K*T_{camera})⁺ denotes a pseudo-inverse of K*T_{camera}, and uᵢ denotes a straight line on which an imaging focus of the camera and the light beam center line projection point images in the light spot images are located.

It should be understood that in the present invention, each related program module in the device of each of the embodiments as mentioned above may be implemented by a hardware processor. In addition, the calibrating device of the present invention can implement calibrating processes for position and orientation of the stage light fixture as mentioned above by using each of the above program modules, and when used to implement the position and orientation calibrating in each of the above method embodiments, the device of the present invention has the same beneficial effects as each of the corresponding method embodiments, and each of the above method embodiments may be referred to, which will not be repeated here.

As another aspect of the present invention, the present invention further provides electronic device according to each of the above embodiments. The electronic device includes a memory, a processor, and a program or instruction stored in the memory and operable on the processor, where when the processor executes the program or instruction, the steps of the method for calibrating position and orientation of the stage light fixture described in each of the above embodiments are implemented.

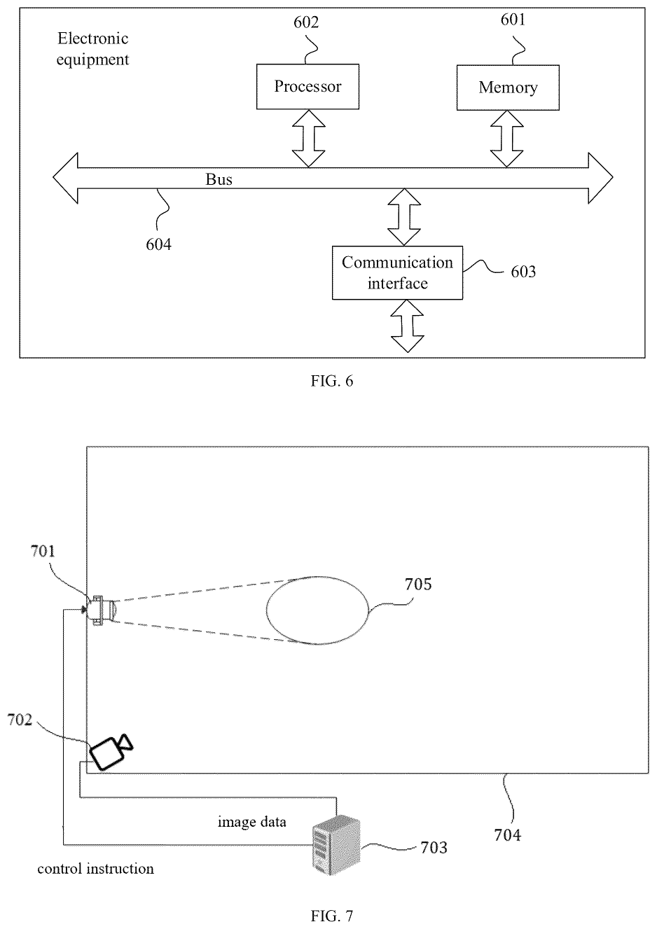

Furthermore, the electronic device of the present invention may also include a communication interface and a bus. Referring to FIG. 6, which is a schematic structural diagram of electronic device provided by the present invention. The electronic device includes at least one memory 601, at least one processor 602, a communication interface 603, and a bus 604.

The memory 601, the processor 602, and the communication interface 603 communicate with one another through the bus 604. The communication interface 603 is used for information transmission between the electronic device and a console and between camera equipment and the console. The memory 601 stores programs or instructions that may run on the processor 602. When the processor 602 executes the programs or instructions, the steps of the calibrating method described in each of the above embodiments are implemented.

In the present invention, the electronic device at least includes a memory 601, a processor 602, a communication interface 603, and a bus 604, and the memory 601, the processor 602 and the communication interface 603 are communicatively connected with one another through the bus 604 and may complete the communication with one another. For example, the processor 602 reads the program instructions of the calibrating method from the memory 601. In addition, the communication interface 603 may also realize the communication connections between the electronic device and the console and between the camera equipment and the console, and may complete the mutual information transmission. For example, the transmission of the spot images and the control instructions is realized through the communication interface 603.

When the electronic equipment runs, the processor 602 invokes program instructions in the memory 601 to execute the method provided by each of the above method embodiments. For example, the method includes: acquiring light spot images and light fixture angle information when light beams of the target stage light fixture respectively project onto at least three different positions on a stage, and respectively calculating first coordinates of a light beam center line projection point image in each of the light spot images in a camera coordinate system, where the light beam center line projection point image is an image of a light beam center line of the target stage light fixture on a floor of the stage; deducing second coordinates of a light beam center line projection point on the stage in a stage coordinate system based on the first coordinates and information about internal parameters and a position and an orientation of a camera when the light spot images are acquired, and recording corresponding relationship between the second coordinates and the light fixture angle information; and determining a calibrated position and orientation of the target stage light fixture based on the second coordinates, the light fixture angle information and the corresponding relationship therebetween.

The program instructions in the memory 601 as mentioned above may be implemented in the form of software function units and may be stored in a computer-readable storage medium when sold or used as a separate product. Alternatively, all or part of the steps for implementing the above method embodiments may be completed by hardware related to program instructions. The above program may be stored in a computer-readable storage medium, and when the program is executed, the steps including the above method embodiments are implemented. The aforementioned storage media include various media capable of storing program codes, such as a U disk, a mobile hard disk, a read-only memory (ROM), a random access memory (RAM), a magnetic disk, or an optical disk.

The present invention further provides a non-transient computer-readable storage medium according to each of the above embodiments, on which a program or instruction is stored, and when the program or instruction is executed by a computer, the steps of the calibrating method described in the above embodiments are implemented. The method includes: acquiring light spot images and light fixture angle information when light beams of a target stage light fixture respectively project onto at least three different positions on a stage, and respectively calculating first coordinates of a light beam center line projection point image in each of the light spot images in a camera coordinate system, where the light beam center line projection point image is an image of a light beam center line of the target stage light fixture on a floor of the stage; deducing second coordinates of a light beam center line projection point on the stage in a stage coordinate system based on the first coordinates and information about internal parameters and a position and an orientation of a camera when the light spot images are acquired, and recording corresponding relationship between the second coordinates and the light fixture angle information; and determining a calibrated position and orientation of the target stage light fixture based on the second coordinates, the light fixture angle information and the corresponding relationship therebetween.

As a further aspect of the present invention, the present embodiment further provides a computer program product according to each of the above embodiments. The computer program product includes a computer program stored on a non-transient computer-readable storage medium, and the computer program includes program instructions. When the program instructions are executed by a computer, the computer can execute the calibrating method provided by each of the above method embodiments. For example, the method includes: acquiring light spot images and light fixture angle information when light beams of a target stage light fixture respectively project on at least three different positions on a stage, and respectively calculating first coordinates of a light beam center line projection point image in each of the light spot images in a camera coordinate system, where the light beam center line projection point image is an image of a light beam center line of the target stage light fixture on a floor of the stage; deducing second coordinates of a light beam center line projection point on the stage in a stage coordinate system based on the first coordinates and information about internal parameters and a position and an orientation of a camera when the light spot images are acquired, and recording corresponding relationship between the second coordinates and the light fixture angle information; and determining a calibrated position and orientation of the target stage light fixture based on the second coordinates, the light fixture angle information and the corresponding relationship therebetween.

The electronic device, the non-transient computer-readable storage medium and the computer program product, provided by the present invention, control the stage light fixture to project on several positions on the stage at will by executing the steps of the calibrating method described in each of the above embodiments, and reversely deduce the coordinates of the light beam center line projection point on the stage according to the light spot images of the positions, so that the deviation caused by manual operation can be effectively eliminated, and improved stability of calibration precision is achieved.

As another aspect of the present invention, an embodiment of the present invention further provides a calibrating system for calibrating position and orientation of the stage light fixture according to each of the above embodiments. As shown in FIG. 7 that is a schematic structural diagram of the calibrating system provided by the present invention, the system includes at least one group of stage light fixtures 701, a camera 702, and a server 703.

The stage light fixtures 701 are in signal connection with the server 703, and the server 703 issues a control instruction to control light beams of a target stage light fixture to respectively project onto at least three different positions on the stage 704.

The camera 702 is installed at a determined position on the stage 704, the camera 702 is in signal connection with the server 703, and the camera 702 is used to acquire light spot images when the light beams of the target stage light fixture respectively project onto the at least three different positions (when the target stage light fixture projects on the floor of the stage 704, corresponding light spots 705 are formed, and an image containing the light spots 705 is collected on the floor of the stage 704 by the camera 702, namely the light spot images are obtained).

The server 703 is used to perform the position and orientation calibrating on the stage light fixture 701 according to the calibrating method described in each of the above embodiments.

It can be understood that the relationship between the server and the stage light fixtures of the present invention is executing and executed relationship, and the server sends out control instructions through signal connection to control the actions of the stage light fixtures.

It can be understood that the server in the present invention may include the computer program in the above embodiments, and when the server executes the computer program, the position and orientation calibrating process in each of the above method embodiments can be implemented. When implementing the position and orientation calibrating of the stage light fixture in each of the above method embodiments, the description and the definition in the calibrating method in each of the above embodiments of the present invention may be used for the understanding of each functional unit in the calibrating system of the present invention, and the calibrating system of the present invention has the same beneficial effect as each of the above corresponding method embodiments, and each of the above method embodiments may be referred to, which will not be repeated here.

It can be understood that the above-described embodiments of the device, the electronic device, and the storage medium are merely illustrative, and elements described as separate components may or may also not be physically separated, may be located in one place, or may also be distributed on different network elements. Part or all of the modules may be selected according to actual needs to achieve the purpose of the present embodiment. Those of ordinary skill in the art may understand and implement the embodiments without creative effort.

Through the description of the above embodiments, those skilled in the art will clearly understand that each embodiment may be implemented by means of software plus a necessary general hardware platform, and may also be implemented by means of hardware. Based on such understanding, the essence of the above technical solution or the part contributing to the prior art may be embodied in the form of a software product, which may be stored in a computer-readable storage medium, such as a U disk, a mobile hard disk, an ROM, an RAM, a magnetic disk or an optical disk, and includes several instructions to enable computer equipment (for example, a personal computer, a server, or network equipment, etc.) to execute the methods of each of the above method embodiments or certain parts of the method embodiments.

In addition, it should be understood by one of ordinary skill in the art that the terms “comprise”, “comprising” or any other variation thereof, in the application file of the present invention, are intended to cover a non-exclusive inclusion, such that a process, a method, an article, or equipment that comprises a list of elements does not include only those elements but may include other elements not expressly listed, or elements inherent to such process, method, article, or equipment. Without more restrictions, elements defined by a statement “comprising a . . . ” does not preclude the presence of additional identical elements in a process, a method, an article, or equipment including the described element.

In the description of the present invention, numerous specific details are set forth. However, it should be understood that embodiments of the present invention may be practiced without these specific details. In some instances, well-known methods, structures, and techniques have not been shown in detail in order not to obscure the understanding of the description. Similarly, it should be understood that in the above description of exemplary embodiments of the present invention, various features of the present invention are sometimes grouped together in a single embodiment, a single figure, or a description thereof for the purpose of streamlining the disclosure of the present invention and aide in the understanding of one or more of the various invention aspects.

Finally, it should be noted that the above embodiments are only used to illustrate the technical solutions of the present invention, not to limit it. Although the present invention has been described in detail with reference to the foregoing embodiments, those skilled in the art should understand that the technical solutions recorded in the foregoing embodiments may still be modified, or some of the technical features thereof may be equivalently replaced. These modifications or substitutions do not make the essence of the corresponding technical solutions deviate from the spirit and scope of the technical solutions of each of the embodiments of the present invention.

What's claimed is:

1. A method for calibrating position and orientation of a stage light fixture, comprising:
acquiring light spot images and light fixture angle information when light beams of a target stage light fixture respectively project onto at least three different positions on a stage, and respectively calculating first coordinates of a light beam center line projection point image in each of the light spot images in a camera coordinate system, wherein the light beam center line projection point image refers to an image of a projection point of a light beam center line of the target stage light fixture on a floor of the stage;
deducing second coordinates of a light beam center line projection point on the stage in a stage coordinate system based on the first coordinates and information about internal parameters and a position and an orientation of a camera for acquiring the light spot images, and recording corresponding relationship between the second coordinates and the light fixture angle information; and
determining a calibrated position and orientation of the target stage light fixture based on the second coordinates, the light fixture angle information and the corresponding relationship therebetween.

2. The method according to claim 1, wherein the method of determining the calibrated position and orientation of the target stage light fixture based on the second coordinates, the light fixture angle information and the corresponding relationship therebetween comprises:
establishing a calibration equation set based on the second coordinates, the light fixture angle information and the corresponding relationship therebetween, and solving the calibration equation set by a nonlinear optimization algorithm to obtain an optimal solution as the calibrated position and orientation of the target stage light fixture.

3. The method according to claim 2, wherein the calibration equation set is as follows:
$${( {l}_{i} , 0 , 0 , 1 )}^{T} = {T}_{light \_ rotation} ( {yaw}_{i} , {pitch}_{i} ) * {T}_{light} * {( {x}_{i} , {y}_{i} , {z}_{i} , 1 )}^{T} , i = 1 … N ,$$
where (xᵢ, yᵢ, zᵢ, 1)^{T} denotes the corresponding second coordinates when the light beams of the target stage light fixture project onto a i^{th} position on the stage, T_{light} denotes a first transformation matrix, which is used to transform the second coordinates into third coordinates of the light beam center line projection point on the stage in a light fixture coordinate system, (yawᵢ, pitchᵢ) denotes the corresponding light fixture angle information when the light beams of the target stage light fixture project onto the i^{th} position on the stage, T_{light_rotation} (yawᵢ, pitchᵢ) denotes a second transformation matrix, which is a known quantity related to the light fixture angle information and is used to transform the third coordinates into fourth coordinates in a rotating coordinate system formed after the target stage light fixture rotates by an angle of (yawᵢ, pitchᵢ), (lᵢ,0,0,1)^{T} denotes the fourth coordinates, lᵢ denotes a distance from an intersection point between the light beam center line of the target stage light fixture and the floor of the stage to an optical center of the light beam of the target stage light fixture, and N denotes the total number of different positions on the stage projected by the target stage light fixture; and
the method of solving the calibration equation set to acquire an optimal solution as the calibrated position and orientation of the target stage light fixture comprises:
solving the calibration equation set to acquire an optimal value of the first transformation matrix as the calibrated position and orientation of the target stage light fixture.

4. The method according to claim 2, wherein the nonlinear optimization algorithm is a Levenberg-Marquardt algorithm.

5. The method according to claim 1, wherein the method of acquiring light spot images and light fixture angle information when light beams of the target stage light fixture respectively project onto at least three different positions on the stage comprises:
controlling the light beams of the target stage light fixture to respectively project onto the at least three different positions to respectively form corresponding light spots; and
respectively collecting images containing the corresponding light spots as the light spot images, and correspondingly recording angle information of the target stage light fixture as the light fixture angle information when the light beams of the target stage light fixture project onto the corresponding positions.

6. The method according to claim 5, wherein the light fixture angle information of the target stage light fixture is determined and recorded by determining rotation information of a horizontal motor and rotation information of a vertical motor of the target stage light fixture.

7. The method according to claim 1, wherein the method of calculating the first coordinates of the light beam center line projection point image in each of the light spot images in the camera coordinate system comprises:
detecting the light spots in the light spot images by a machine vision algorithm, and determining a position of the light beam center line projection point image according to brightness distributions and shapes of the light spots; and
calculating the first coordinates of the light beam center line projection point image in the camera coordinate system according to the position of the light beam center line projection point image.

8. The method according to claim 1, wherein light spot center points on the ground of the stage are taken as the projection point of the light beam center line of the target stage light fixture on the floor of the stage, and accordingly, the light spot center points in the light spot images are taken as the light beam center line projection point images.

9. The method according to claim 8, wherein the method of calculating the first coordinates of the light beam center line projection point image in each of the light spot images in the camera coordinate system comprises:
detecting the light spots in the light spot images by a machine vision algorithm, and solving coordinates of the light spot center points in the light spot images in the camera coordinate system as the first coordinates of the light beam center line projection point image by a corresponding geometric algorithm according to a geometric characteristic of the light spots in the light spot images.

10. The method according to claim 9, wherein the light spots in the light spot images are in the shape of an ellipse, the elliptic light spots in the light spot images are detected accordingly by an ellipse detection algorithm, center points of the ellipse light spots are detected as the light spot center points in the light spot images according to geometric symmetry of the elliptic light spots, and the first coordinates of the spot center points in the spot images are calculated.

11. The method according to claim 1, wherein the method of deducing second coordinates of the light beam center line projection point on the stage in the stage coordinate system based on the first coordinate and information about internal parameters and the position and orientation of the camera when the light spot images are acquired comprises:
determining a back projection ray by a back projection method based on the first coordinates and the information about the internal parameters and the position and the orientation of the camera; and
based on the back projection ray, determining corresponding points of the light beam center line projection point images in the light spot images on the floor of the stage as the projection points of the light beam center lines on the floor of the stage, and calculating the second coordinates of the projection points in the stage coordinate system.

12. The method according to claim 11, wherein if the first coordinates of the light beam center line projection point images in the light spot images when the light beams of the target stage light fixture project onto the i^{th} position on the stage are (xᵢ^{pixel}, yᵢ^{pixel})^{T}, the back projection ray in the camera in the stage coordinate system is denoted as:
$${u}_{i} = {( K * {T}_{camera} )}^{+} * {( {x}_{i}^{pixel} , {y}_{i}^{pixel} , 1 )}^{T} ,$$
where K,T_{camera} denotes the information about the internal parameters and the position and the orientation of the camera, respectively, (K*T_{camera})⁺ denotes a pseudo-inverse of K*T_{camera}, and uᵢ denotes a straight line on which an imaging focus of the camera and the light beam center line projection point images in the light spot images are located.

13. A device for calibrating position and orientation of a stage light fixture, comprising:
a first processing module, configured to acquire light spot images and light fixture angle information when light beams of a target stage light fixture respectively project onto at least three different positions on a stage, and respectively calculate first coordinates of a light beam center line projection point image in each of the light spot images in a camera coordinate system, wherein the light beam center line projection point image is an image of a projection point of a light beam center line of the target stage light fixture on a floor of the stage;
a second processing module, configured to deduce second coordinates of a light beam center line projection point on the stage in a stage coordinate system based on the first coordinates and information about internal parameters and a position and an orientation of a camera for acquiring the light spot images, and record corresponding relationship between the second coordinates and the light fixture angle information; and
a calibrating module, configured to determine a calibrated position and orientation of the target stage light fixture based on the second coordinates, the light fixture angle information and the corresponding relationship therebetween.

14. An electronic device, comprising a memory, a processor, and a program or instruction stored in the memory and operable on the processor, wherein when the processor executes the program or instruction, the steps of the method according to claim 1 are implemented.

15. A non-transient computer-readable storage medium, on which a program or instruction is stored, wherein when the program or instruction is executed by a computer, the steps of the method according to claim 1 are implemented.

16. A computer program product, comprising a computer program stored on a non-transient computer-readable storage medium, wherein the computer program comprises a program instruction, and when the program instruction is executed by a computer, the computer is configured to execute the method according to claim 1.

17. A system for calibrating position and orientation of a stage light fixture, comprising at least one group of stage light fixtures, a camera, and a server, wherein
the stage light fixtures are in signal connection with the server, and the server is configured to issue a control instruction to control light beams of a target stage light fixture to respectively project onto at least three different positions on a stage;
the camera is installed at a determined position on the stage and in signal connection with the server, and the camera is used to acquire light spot images when the light beams of the target stage light fixture respectively project onto the at least three different positions; and
the server is configured to calibrate a position and orientation of the target stage light fixture according to the method according to claim 1.
